(19) United States
(12) Patent Application Publication
(10) Pub. No.: US 2014/0041801 A1
(43) Pub. Date: Feb. 13, 2014

(54) ASSEMBLY FOR TRANSPORTING REELS WITH WOUND FOIL AND METHOD FOR ARRANGING FOIL ONTO A CONTAINER

(71) Applicant: FUJI SEAL INTERNATIONAL, INC., Osaka-shi (JP)

(72) Inventors: Lucas VAN RIJSEWIJK, Boxtel (NL); Ernst Christiaan KOOLHAAS, Nuenen (NL); Takeshi KYOGANE, Chatham (GB)

(21) Appl. No.: 13/961,419

(22) Filed: Aug. 7, 2013

(30) Foreign Application Priority Data
Aug. 7, 2012 (NL) 2009289

(51) Int. Cl. B65C 3/00; B65H 18/28; B65D 19/00

(52) U.S. Cl. CPC B65C 3/00; B65D 19/0004; B65H 18/28
USPC 156/250; 108/50.17

(57) ABSTRACT

The invention relates to an assembly of reels and transport platforms. The reels comprise foil to be arranged as labels onto containers. The invention also relates to a method for arranging a label onto a container at a labelling plant. According to the method containers and labels are provided at the labelling plant. The labels are arranged onto the containers. At a foil production plant, at least 80 mm of foil height of foil comprising labels is wound onto a deformable core with an opening. This forms a reel. Three or more reels are positioned on a transport platform such as a pallet for transporting to the labelling plant. Two of the reels are ovally shaped having an oval ratio (R_{lw}) of length:width of at least 1.1. At the labelling plant the foil is unwound from the reel and cut into labels.

The invention relates to an assembly to transport reels of wound foil. The invention further relates to a method for arranging foil onto a container, specifically sleeves around a container, including the transport of the foil.

Labelling a container using a plastic, preferably heat shrinkable, foil is an efficient method for labelling containers.

Labels are formed from foil having a desired print. The foil is printed at a foil production plant. Labels are arranged onto the container at a labelling plant. To transport the foil efficiently from foil production plant to the labelling plant, the printed foil is wound onto a core forming a reel. These reels are loaded onto a support surface such as a pallet. At the labelling plant the foil is unwound from the core. The foil can be cut into separate labels, e.g. sleeves, and are arranged onto the container.

A core can be a tube having an opening. This allows mounting the core/reel in a winding device. Known reels have a generally circular shape.

The inventors realized that shipping of the circular reels is inefficient. A large part of the support surface is not used for transporting/supporting foil. It is a goal of the invention to transport foils more efficiently.

According to an aspect of the invention an assembly for transporting reels with wound plastic foil is provided. In an embodiment the assembly comprises a transport platform, such as a pallet, having a support surface and reels. A reel comprises plastic foil wound around a tubular core. The core has an opening. The plastic foil comprises labels to be arranged onto containers.

According to an embodiment of the invention at least three reels with wound foil are positioned with a side face of the reel on the support surface. The reels are positioned according to a suitable pattern, dependent on the size of the support surface and the size of the side face of the reel.

According to an embodiment of the invention at least two, preferably at least three and more preferably at least four of the reels are positioned on the support surface, each reel having the following properties:
have at least 80 mm of foil height wound around the core; have cores formed from deformable material;
are ovally shaped in cross section, the opening of the core having an oval ratio (R_{lw}) of length:width of at least 1.1, preferably at least 1.5 and more preferably at least 1.8. Reels having such properties will allow increasing the transport efficiency significantly. In particular the invention will allow transporting one or more reels extra on the same surface area of the support surface, thereby lowering the transport costs. By positioning ovally shaped reels onto a platform, more reels can be fitted onto the platform, resulting in more efficient transport.

The foil height is defined as the height of the layers of foil wound around the core. A 80 mm foil height around a 254 mm core diameter corresponds with at least 900 meters of tubular foil having a 35 μm foil layer thickness. Other foil thicknesses such as 20, 25, 30, 40, 45, 50, 60 and/or 70 um are also possible. Preferably the foil or tubular foil is 100 mm wide foil.

In an embodiment the foil height is limited to about 140 mm, preferably at most 130 mm. This limits the amount of foil on the reel, limiting the weight of the reel. Too much weight would result in difficult handling of the reel by the operator.

In an embodiment the oval ratio (R_{lw}) of length:width is limited to at most 8, preferably at most 7.5 and more preferably at most 7.4. Higher oval ratios have detrimental consequences for the quality of the foil, such as overstretching.

The support surface has a certain surface area. The foil wound around the core will cover a certain surface area. By ovally shaping the reel, the surface area of the opening of the core will be reduced. In an embodiment a cover percentage can be defined as the surface area of only the wound foil divided by the total surface area of the support surface.

It should be noted that the support surface of a transport platform is smaller than the surface area of the transport platform. E.g. a 1200×1200 mm transport platform will generally have a support surface of approximately 1150×1150 mm. In such a case a strip of about 25 mm wide is available around the outer circumference for e.g. packaging.

According to an embodiment the invention a cover percentage is at least 40%, preferably at least 45% and more preferably at least 50%. As a result of the minimum length of foil and the minimum ratio for the oval form of the reel, the cover percentage is increased.

In an embodiment the cover percentage of wound foil on the support surface is at least 40% in case of three reels positioned on the support surface. In an embodiment the cover percentage is at least 44% in case of at least four reels positioned on the support surface. In an embodiment five reels are positioned on the support surface having a cover percentage of at least 48%. In a further embodiment six reels are positioned on the support surface having a cover percentage of at least 48%. In yet a further embodiment eight reels are positioned on the support surface having a cover percentage of at least 60%.

In an embodiment the reels positioned on the support surface are arranged according to one or a combination of the following patterns, wherein ‘−’ represents a reel in a longitudinal orientation ('=' represents two reels), ‘|’ represents a transverse orientation of the reel on the support surface, and ‘/’ represents an acute position of the reel:

Length × width of transport platform

| | | | | | | | | | |
|---|---|---|---|---|---|---|---|---|---|
| 1200 × 800 | \| \| | \| \| \| | \|= | -- | -- | | | | |
| | | | | -- | -- | | | | |
| | | | | | -- | | | | |
| 1000 × 1200 | \| \| | -\| | \| \| | / / | -/ | \| \| \| | =/ | / / / | \| \| \| \| |
| | \| \| | \|- | \| | \| \| \| | - | \| \| \| | =/ | \| \| \| \| | \| \| \| \| |
| | | | \| \| | | -/ | | | | |
| 1200 × 1200 | \| \| | -\| | \| \| | / / | \| \| \| | / / / | \| \| \| \| | =\| \| | |
| Or | \| \| | \|- | \| | \| \| \| | \| \| \| | \| \| \| \| | \| \| \| \| | \| \|= | |
| 1100 × 1100 | | | \| \| | | | | | | |

In an embodiment the pattern is a pattern having at least four reels, preferably at least six. For 1200×1200 platform preferably 8 reels are positioned in a single layer.

In an embodiment the ratio of foil height (h) of foil wound around the core and oval ratio (R_{lw}) is given by the following formula, height (h) in millimetres,

80<h<−0.6·R_{lw}⁴+10·R_{lw}³−64·R_{lw}²+182·R_{lw}+33 (1).

Formula (1) specifically relates to reels having possible unlimited foil heights. Those reels could be lifted using lifting devices.

In an embodiment the ratio of foil length (L) of foil wound around the core and oval ratio (R_{lw}) is given by the following formula:

90<h<152·R_{lw}^{-0.1} (2).

Formula 2 specifically relates to reels having discrete foil lengths, such as 1000 m, 1200 m, 1500 m and 2000 m.

It was discovered by the inventors that the longer the length of foil wound around the core, the less oval the reel should be, in an embodiment specifically in combination with patterns of at least 5 reels on a single surface area of a transport platform. An exemplary embodiment is 95-110 mm foil height wound around a core. The oval ratio of the core could be around 7, e.g. 5-7.4. Another exemplary embodiment is 115-180 mm foil height wound around a core. The oval ratio of the core is less, around 2.5, e.g. 1.1-3.5.

In an embodiment the ovally shaped reels are shaped close to rounded rectangulars. The long side of the oval reel is close to a straight line. This allows efficient abutting of the reels when positioned on the support surface. The long sides of adjacent oval reels abut over a large part of the foil layer, whereas before the invention the adjacent reels would point contact an adjacent reel.

In an embodiment at least two reels have at least 1150 meter of foil or at least 100 mm of foil height wound around the reel.

In an embodiment a single support surface can support reels of different lengths. This will allow a higher filling/coverage percentage of the support surface, e.g. by using specific lengths reels to most efficiently fill the support surface.

In an embodiment the layer of foil wound around the core is at least 100 mm thick, preferably at least 115 mm.

In an embodiment the support surface of the transport platform is at least 740 mm wide and at least 740 mm long. Preferred transport platforms are dimensioned: 800 mm×1200 mm, 1000 mm×1200 mm, 1100 mm×1100 mm and/or 1200 mm×1200 mm.

In an embodiment using a 800×1200 mm transport platform, the oval ratio (R_{lw}) is between 1.5 and 3.1. It was found that for this domain of the oval ratio the cover percentage is maximised using a core of about 255 mm diameter.

In an embodiment using a 1000×1200 mm transport platform the oval ratio is at least 2, preferably at least 2.5.

In an embodiment the support surface is surrounded by a circumferential edge extending upwardly from the support surface. Preferably the circumferential edge is formed by a cardboard boxing. The cardboard boxing is preferably about 50 mm less wide than the pallet onto which it is positioned. This will prevent the reels from losing the oval shape during transport. In some embodiment the oval reels tend to re-form to a circular reel. By providing a boxing this is prevented.

In an embodiment the core is formed from cardboard. In an embodiment the diameter of the core is at least 200 mm, preferably at least 240 mm and preferably less than 300 mm, more preferably less than 260 mm. In an embodiment a cylinder wall of the core has a thickness between 2 mm and 5 mm. In an embodiment the core has a circumference between 64.1 cm and 97.4 cm.

According to a further aspect a method for arranging a label onto a container is provided. According to the method the label is arranged onto the container at a labelling plant. The method can comprise providing containers at the labelling plant, providing labels at the labelling plant and arranging labels onto the containers. According to the method different foil and labels can be used. The invention is independent from the size of the label as well as size, shape or material of the container.

In an embodiment labels are provided at the labelling plant by unwinding the foil from the reel at the labelling plant and cutting the unwound foil into labels.

In embodiment the reels with wound foil are formed at a foil production plant and are transported from the foil production plant to the labelling plant.

In an embodiment, at a foil production plant, at least 80 mm foil height comprising labels is wound onto a deformable core, thereby forming a reel. The foil height is a preferred parameter for indicating the length of the foil wound around the core, as core height is independent from the foil thickness. With decreasing foil thickness, more foil can be wound around the core, increasing the length of the foil. The foil height is also a general indication for the weight of the reel including the foil. The weight of the reel preferably is maximized at 25 kg, preferably at most 20 kg.

In an embodiment at least 900 meters of foil is wound around the core. Preferably a tubular foil is wound around the core. Preferably the foil is at most 50 μm thick, preferably less than 35 μm. In an embodiment at most 1700 meters of 30-40 μm thick foil is wound around the core.

In an embodiment transporting the reel from the foil production plant to the labelling plant comprises positioning at least three reels with a side face onto a support surface of a transport platform. Of the at least three reels at least one reel is ovally shaped in cross section, the opening of the reel having a oval ratio (R_{lw}) of length:width of at least 1.1, preferably at least 1.5, more preferably at least 2.

Accordingly a method is provided wherein labels are arranged onto container more efficiently as, independent from the actual labelling method, the foil is transported more efficiently from the foil production plant to the labelling plant. Reels fit more efficiently on a support surface. In an embodiment more reels fit on the same support surface area.

In an embodiment the foil height, and correspondingly the length of the foil wound around the core is generally maximised. A transport platform having a support surface for positioning reels can support multiple reels in accordance with a pattern. The pattern will define an available surface space for each reel. Within the available surface space, the foil length of foil wound around the core can be generally maximised, that is close to maximum. Generally maximised can be defined as at least 90% of the maximum, preferably at least 95% of the maximum.

In an example the available width of the support surface is 4x. Four reels are fitted next to each other. The available width for each reel is x. If the core has a diameter of x/3, then x/3 is available as maximum height for wound foil around the container. x/3 will correspond with a certain length of the foil. According to an embodiment at least 0.9 of x/3 and preferably at least 0.95 of x/3 of foil is wound around the core.

The reel, core, foil and support surface used in the method can have any combination of properties as indicated above.

In an embodiment the method comprises deforming the reel at the foil production plant from generally circular reel wound around the reel to the ovally shaped reel.

In an embodiment the foil is wound onto an ovally shaped core.

In an embodiment unwinding the foil from the reel comprises deforming the ovally shaped reel in a generally circular reel prior to unwinding.

In an embodiment unwinding the foil from the reel comprises unwinding the foil from the ovally shaped reel.

In an embodiment the foil is a tubular foil. In an embodiment cutting labels comprises forming sleeves. In an embodiment arranging the label onto the container comprises arranging the sleeve around the container.

It will be clear to the skilled person that the drawing shows only preferred embodiments, and that other embodiments fall within the scope of the invention. Although the drawing will show preferred embodiments, and the invention was described with the appended claims, it will be clear to the skilled person that the invention can encompass other features mentioned explicitly in this description, but also implicit features. It will be clear to the skilled person that any of these explicit or implicit features can be combined with features mentioned in this description or in the claims. Divisional applications directed at these features are possible.

Embodiments will now be described referring to the drawing, wherein:

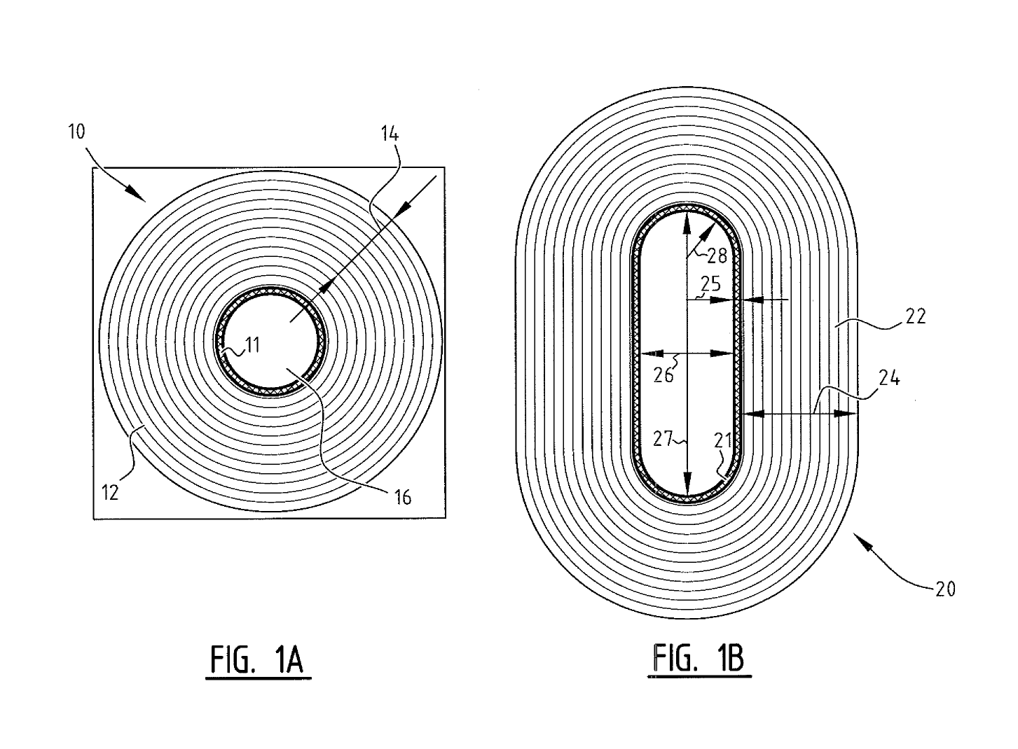

FIG. 1a and FIG. 1b show top views of reels according to an embodiment of the invention;

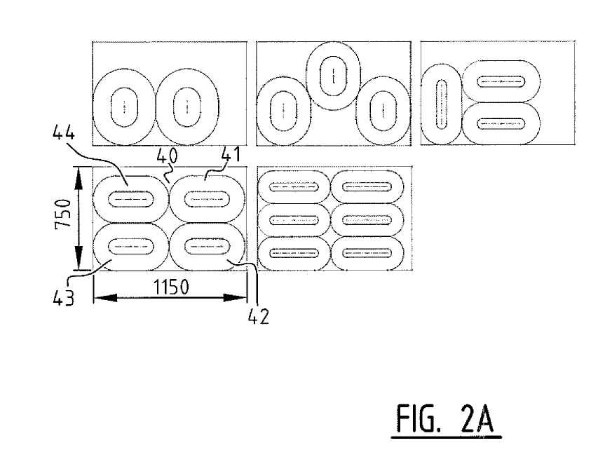

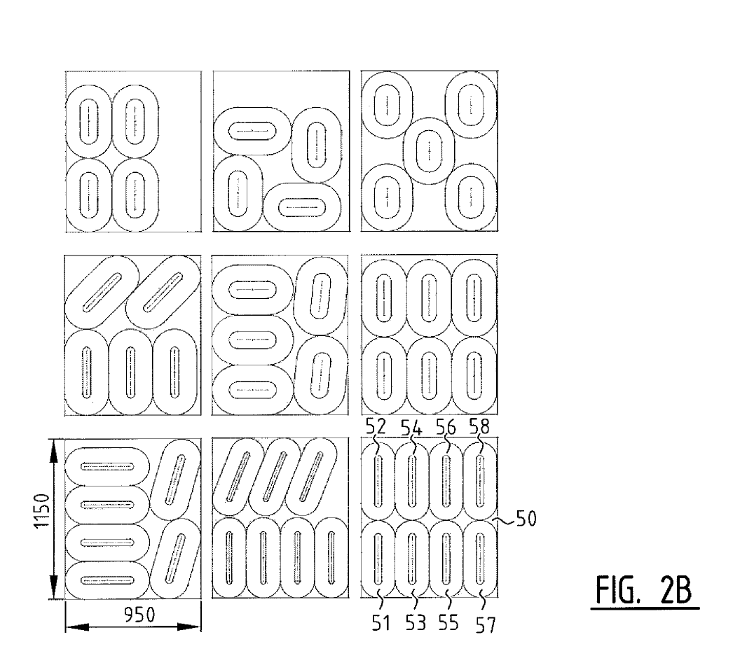

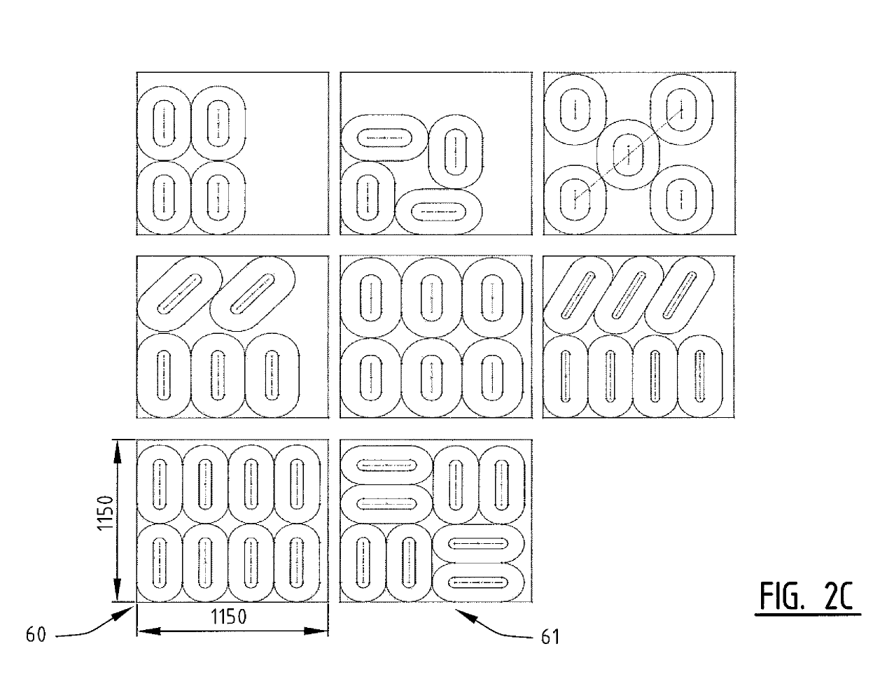

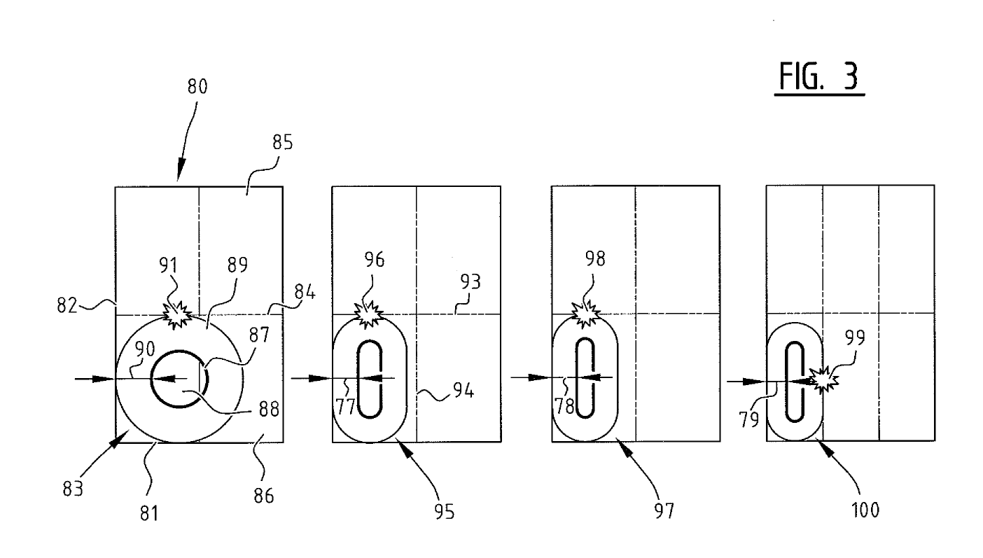

FIGS. 2a-3c are overviews of embodiments of assemblies according to the invention;

FIG. 3 shows four examples of fitting reels on a support surface;

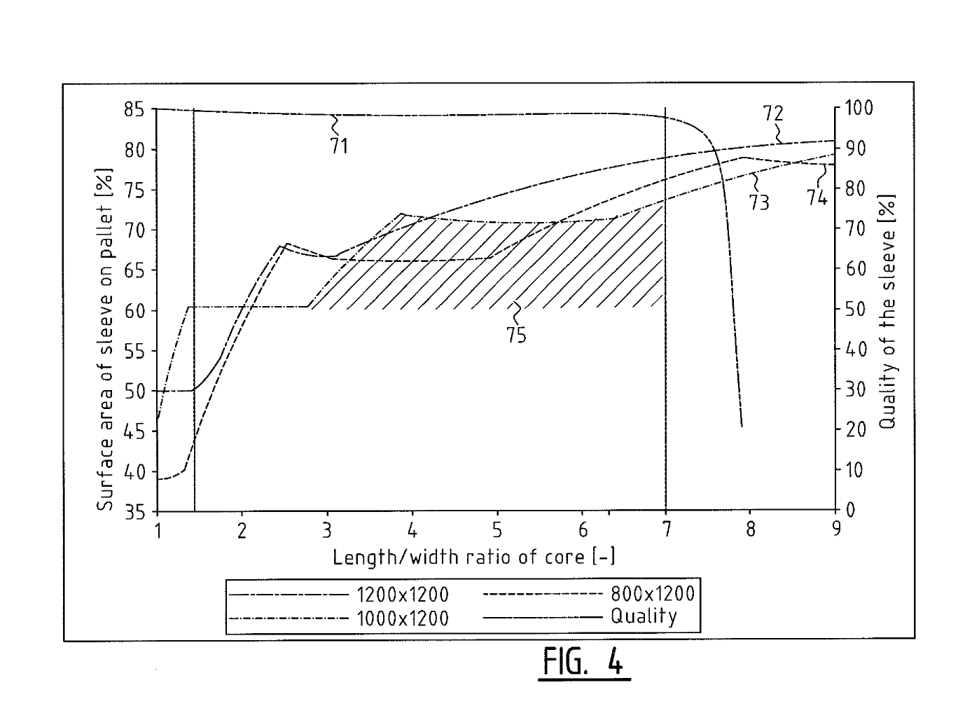

FIG. 4 is a graph showing a quality parameter and coverage percentage as a function of the oval ratio;

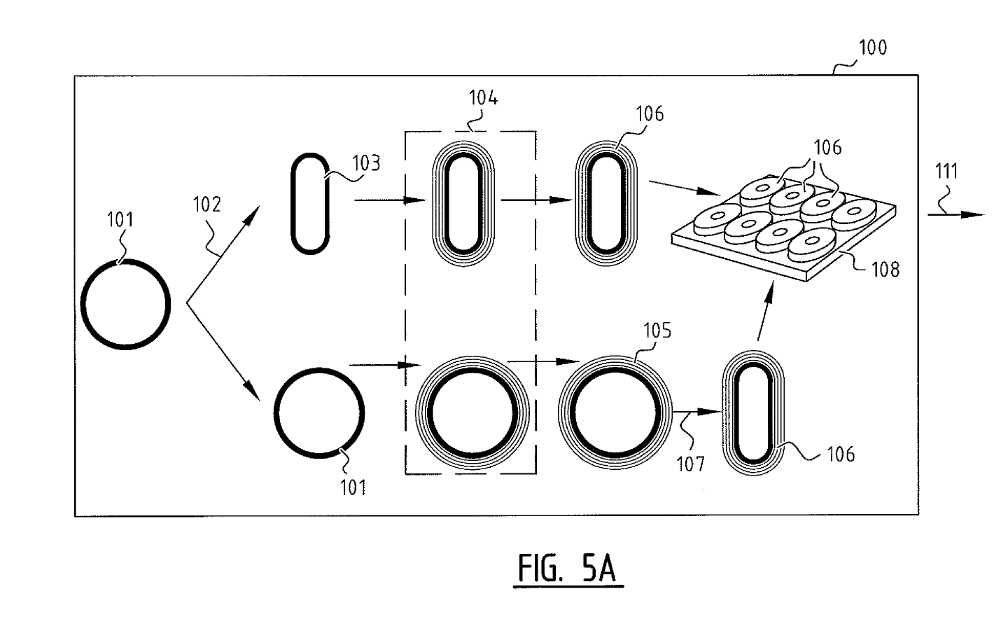

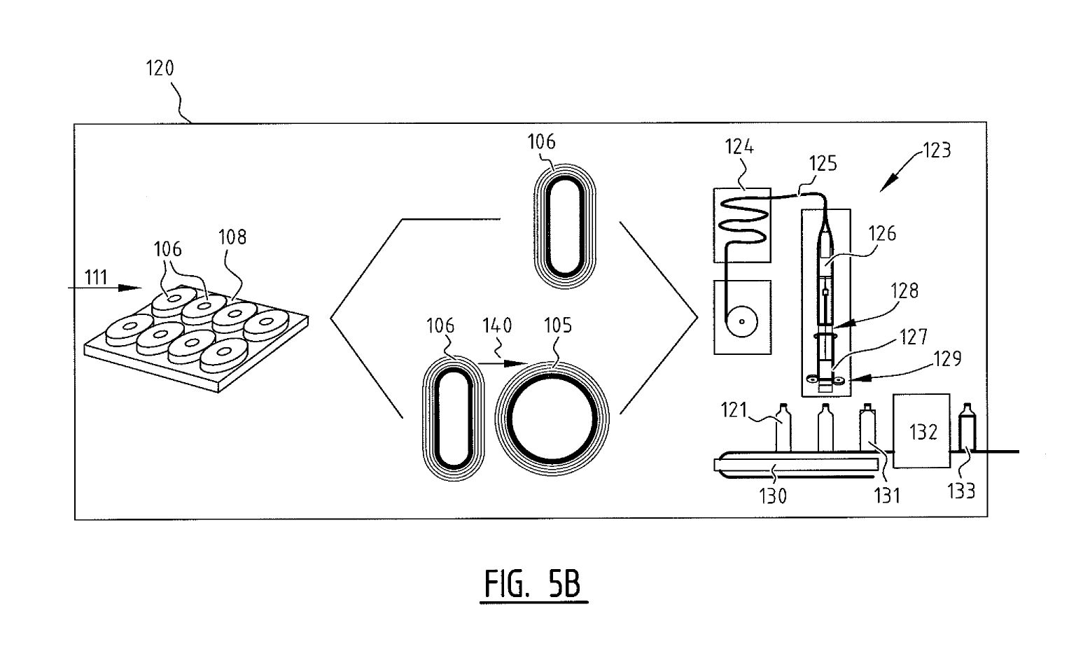

FIGS. 5a and 5b show schematic representations of several embodiments of the method according to the invention.

FIG. 1a shows a top view of a reel 10 comprising a tubular core 11 and foil 12 wound around the core 11. The reel is circular in cross section as clearly visible in the top view.

Foil 12 is wound around the core 11 and forms several stacked layers. The layers are illustrated schematically only. The length of the foil 12 can be more than 850 meters. In this embodiment the combined wound layers are h_{foil} thick, indicated by arrow 14.

Core 11 is formed from a rigid material showing some flexibility. Core 11 can be made of plastic or cardboard. Core 11 has an opening 16. Core 11 has an external surface of pi×D_{core,oxt}, wherein D_{core,ext} is the diameter of the core's external surface. In an embodiment the D_{core,ext} is between 25 and 28 cm. D_{core,int} is the diameter of the internal surface of the core. 0.5×(D_{core,ext}−D_{core,int}) is the thickness of the core and can be in the order of 2-5 mm.

The surface area covered by core and foil in this embodiment is:

A_{covered}=0.25×pi×(D_{core,ext}+2×h_{foil})²−0.25×pi×D_{core,int}²=pi×h_{foil}(D_{core,ext}+h_{foil}) (wherein D_{core,ext}≈D_{core,int})

If the reel 10 is positioned on a square transport platform of having a width (D_{core,ext}+2×h_{foil}) the coverage percentage is:

A_{cover,%}=A_{covered}/(D_{core,ext}+2×h_{foil})²

FIG. 1b shows schematically (not same scale as FIG. 1a) a similar reel 20 in top view. Reel 20 is non circular, oval shaped. In this embodiment the reel's cross section is a rounded rectangular as shown.

Reel 20 comprises a core 21 and foil 22. Foil 22 is wound around the core's external surface forming a layer of foil of thickness 24. Core 21 has a thickness 25.

Core 21 is deformed (not stretched) with respect to the default circular core 11 in that it has an oval shape, indicated by length 27 and width 26. The oval ratio is given by length 27/width 26. In the shown embodiment the ratio is about 3.

A suitable pressure device can be used to deform the circular core 11 to oval core 21, similarly deforming the foil 22 if the foil is already wound around the core.

FIGS. 2a-c schematically show in top view of several embodiments of assemblies of three different sized transport platforms. The transport platforms can be pallets or similar carriers providing a support surface allowing to position several reels on that surface. In this embodiment the reels are positioned flat with the tubular axis extending out of the support surface. Please note that the reels and platforms are not in scale.

Three support surfaces of different sized transport platforms are indicated: 750×1150 mm, 950×1150 mm and 1150×1150 mm for transport platforms sized 800×1200 mm, 1000×1200 mm and 1200×1200 mm respectively.

Reels having at least 80 mm of foil height (e.g. at least 900 meters of tubular foil having 30-40 μm thickness) and having a core with a diameter of about 260 mm can be fitted on the transport platform.

In combination with a 800×1200 mm platform, FIG. 2a, preferably four reels 41-44 are positioned on the transport platform 40. The reels are oval-shaped and have an oval ratio between 1.5 and 7.5, preferably 1.4-2.6. Preferably six reels having less than 125 mm foil height can fit on a transport platform having a ratio of at least 4.5 and at most 7.3.

In combination with a 1200×1000 mm platform, FIG. 2b, preferably eight reels 51-58 can be positioned on the transport platform 50. In such an embodiment the foil height is less than 110 mm. The eight reels are oval-shaped and have an oval ratio of at least 4.

In a preferred embodiment however a five reel pattern comprising three horizontal and two vertical reels is the preferred pattern. The oval ratios of the reels will be in the order of 1.6-3.1, preferably about 1.7-2.4. In a five reel pattern, more than 110 mm foil height can be wound around the core.

Also in combination with a 1200×1200 mm platform, FIG. 2c preferably eight reels are positioned on the transport platform. The reels are oval-shaped and have an oval ratio between 1.1 and 7.3, preferably 2.4-7. The arrangement pattern of the reels can be two rows of four oval shaped reels, pattern 60. Pattern 61 shows an alternative.

For a 1200×1200 mm platform a six reel pattern is preferred for reels having more than 100 mm foil height. The oval ratio for this pattern is in the order of 1.3-2.5.

Preferably however a 1200×1200 mm platform support a eight reel pattern, preferably a rotational pattern. The foil height is limited to about 115 mm.

Although FIGS. 2a-c show several embodiments, clearly more patterns are possible with in the scope of the invention.

FIG. 3 shows four examples of fitting a close to maximum amount of foil on cores to form reels that can be transported efficiently using transport platforms.

A support surface 80 has a width 81 and length 82. The support surface can support reels 83. One reel 83 is shown. Reel 83 comprises a core 87. Core 87 has a diameter 88. Foil 89 is wound around the core 88 having a foil height 80.

In the embodiment of the left-hand figure of FIG. 3, support platform 80 is a 1200×800 platform. A 1200×800 mm transport platform will have a useable support surface of about 1150×750 mm, e.g. defined by a cardboard boxing having a surrounding, upwardly extending edge. The support surface is divided by dotted line 84 in two artificial support areas 85,86. The support surface in this embodiment is arranged to support two reels, according to the first pattern of FIG. 2.

As a result reel 83 (core+foil) can have a maximum diameter of length/2, e.g. 575 mm. If the core outer radius is about 260 mm and the oval ratio (R_{lw}) is as indicated about 1, the foil height can be maximized and is about 157 mm. The foil height is limited as a result of the foil height ‘colliding’ with dotted line 84 at 91. The cover percentage of foil covering the support surface is about 48%.

However 157 mm foil height corresponds generally with more than 25 kg of foil. This is too much of a load for an operator. Such reels are less preferred.

The second example shows the same support surface size, however now a 2×2 pattern allowing to position four reels on the support surface is envisaged. The 2×2 pattern is indicated by dotted lines 93,94. As the formed artificial cells into which a reel is to be fitted are now of more rectangular form, the oval ratio (R_{lw}) of the core is increased. In the shown embodiment, reel 95 has an oval ratio (R_{lw}) of about 3.4. The circular core of reel 95 would have a diameter of about 255 mm. Accordingly the invention allows maximizing the amount of heat shrinkable foil to be wound around the core. The reel 95 having an oval ratio (R_{lw}) of 3.4 will be limited by its length as with increasing foil length, the reel will collide at 96 with dotted line 93. In this example the foil height 77 is about 115 mm corresponding with about 1450 meters of 35 μm foil of 100 mm wide, having a weight of about 15 kg. Such a deformed reel 95 with foil will cover about 62% of the surface area with foil.

A third example shows that for a 1200×800 transport platform using a 2×2 pattern for reels, that with increasing oval ratio (R_{lw}), in this example about 4.4, the amount of film that is wound around the core decreases. As the ratio increases, less film can be wound around the core as the amount of foil is limited in the length direction indicated by collision 98. Reel 97 will have a foil height 78 of about 110 mm resulting in a cover percentage of about 58%.

In a fourth example, shown on the right hand side of FIG. 3, a 2×3 pattern for arranging reels onto a 1200×800 transport platform having a 1150×750 support surface is illustrated. Now the amount of foil wound around the core is limited in the width direction indicated by collision 99. Again using a core having a 254 mm diameter if circular, about 88 mm foil height 79 can be wound around a core if the oval ratio (R_{lw}) is about 4.75. This results in a cover percentage of about 65%. However the amount of film wound around the core is 950-1050 meters when a 30-40 μm film is used. With the introduction of thinner film (less then 50 um) a higher operator efficiency was also introduced by placing more film on a reel. A foil height of less than 80 mm is less preferred in case of 35 μm foil.

FIG. 4 shows several experimental results for different oval ratios as shown on the x-axis of the graph as simulated for maximised foil height. With increasing oval ratio, the number of reels that can be positioned on the pallet can increase. As the number of reels on the pallet increases, the coverage percentage increases.

However the graph limited the foil height, and therefore the foil length or foil weight to be wound around the core within a predetermined domain. About 15-20 kg of foil should be wound around the core in order to allow a high efficiency of transport and reel handling on the one hand (minimum amount of foil), and allow an operator to manually handle the reel on the other hand (maximum weight).

The graph also shows the quality of the sleeve. The quality parameter indicates that if the ratio is too high, e.g. higher than 7.5, that the quality of the foil decreases significantly. Quality loss can be the result of deformation.

FIG. 4 simulates the examples of FIG. 3 for various transport platform sizes (1200×800, 1000×1200, 1200×1200) as a function of the oval ratio (R_{lw}). The oval ratio (R_{lw}) is shown as the parameter on the x-axis of the graph.

For a 1200×800 transport platform the cover percentage is, with a ratio lower than 1.3 about 39%. With increasing oval ratio (R_{lw}) a rapid increase in the cover percentage occurs at oval ratio R_{lw}>1.3 as now a pattern of 2×2 reels can be fitted on the support surface area. The length of the foil (foil height) can be increased up until an oval ratio (R_{lw}) of about 2.6 resulting in a maximum cover percentage of about 68% in case of a 2×2 reel pattern. At higher oval ratios (R_{lw}) the cover percentage decreases for patterns comprising at most four reels as the maximum amount of foil wound around the core will decrease. At an oval ratio of about 4.9 a pattern of 2×3 reels can be fitted on the support surface with a maximum cover percentage of about 79% at an oval ratio (R_{lw}) of about 7.9.

For a 1000×1200 mm and a 1200×1200 mm transport platform the graphs 72,73 (and thus the cover percentage) increase with higher oval ratios (R_{lw}).

Best results for a 1000×1200 transport platform are available having an oval ratio (R_{lw}) between 3.5 and 7, having a foil height of about 105 mm resulting in a cover percentage of about 72%, wherein the reels are arranged on the transport platform according to a 2×3 pattern.

Best results for a 1200×1200 transport platform are available having an oval ratio (R_{lw}) between 5 and 7, having a foil height of about 110 mm resulting in a cover percentage of about 77%, wherein the reels are arranged on the transport platform according to a 2×4 circular pattern.

In accordance with embodiments of the method and assembly of the invention, the foil length can be maximised up until 90%, in a preferred embodiment 95%.

For a 1000×1200 transport platform a cover percentage between 62% and 75% having an oval ratio (R_{lw}) between 2.8 and 7.4 as indicated by the shaded area 75 in FIG. 4 would be a significant efficiency increase in accordance to the method and assembly of this invention.

For 1000×1200 mm the cover percentages increase starting with a 1.1 ratio.

For a 1200×1200 transport platform a cover percentage between 62% and 79% having an oval ratio (R_{lw}) between 2.1 and 7.4 would be a significant efficiency increase in accordance to the method and assembly of this invention.

FIG. 5a shows embodiments of methods steps as performed at the foil production plant 100. A core 101 is in step 102 deformed in order to obtain the oval shape 103. Either core 101 or oval shaped core 103 is loaded into a schematically indicated foil winding apparatus 104. The core 101 or 103 is loaded and heat shrinkable foil is wound around the core, resulting an oval reel 106 or reel 105. Winding the foil on a oval core, while maintaining the oval shape, results in an oval shaped reel 106.

At least 900 meters of foil is wound around the core in the winding apparatus 104.

In an embodiment the core 103 is produced having an oval shaped. The deformation step 102 is not a necessary step of the invention.

In step 107 the reel 105 is deformed resulting in a similarly oval shaped reel 106. A machine exerting a force in opposite directions on the inside of the core can be used.

Subsequently the oval shaped reels 106 are positioned on a support surface of the transport platform 108. The transport platform can have a cardboard boxing.

In transport 111 several layers of transport platforms can be stacked on top of each other, allowing efficient transport of a number of reels from the foil production plant 100 to the labelling plant 120.

FIG. 5b shows several embodiments for handling of the labelling of containers 121 at the labelling plant 120.

Reels 106 are taken from the transport platform and can be loaded into a splicer 122 as is generally known for labelling plants. Splicer 122 can connect subsequent strips of foil that are fed to a labelling apparatus 123. Through a buffering device 124, allowing the continuous feed of foil 125 to the labelling apparatus. When a new reel is loaded, buffering device 124 supplies foil to the labelling apparatus.

In this embodiment a tubular, heat shrinkable foil is wound around the reel. Other foils are possible within the invention.

The tubular foil 125 is fed over a mandrel 126. By cutting 128 sleeve 127 is formed. Sleeve 127 can be ejected from the mandrel using a discharge unit 129 over a container 121. Containers are conveyed on a transporter 130 under the mandrel 126. The sleeved container 131 is transported into a heat over 132. The heat will shrink the sleeve 127 arranged around the container creating the labelled container 133.

The oval shaped reel 106 can, in step 140, be deformed from its oval shape to the generally circular shape. Either the oval shaped reel 106 or the circular reel 105 is loaded in the splicer.

Clearly other labelling methods can be employed in combination with the invention.

What is claimed is:

1. Assembly for transporting reels with wound plastic foil for labelling containers, the assembly comprising at least:
a transport platform, such as a pallet, having a support surface; and
reels with plastic foil wound around a tubular core, the core having an opening, the plastic foil comprising labels to be arranged onto containers, wherein at least three reels with wound foil are positioned with a side face of the reel on the support surface, of which at least two reels:
have at least 80 mm foil height wound around the core;
have cores formed from deformable material;
are ovally shaped in cross section, the opening of the core having an oval ratio (Rlw) of length:width of at least 1.1.

2. Assembly according to claim 1, wherein the plastic foil is a heat shrinkable foil and/or wherein the plastic foil is a tubular foil.

3. Assembly according to claim 1, wherein the oval ratio is at most 7.4 and/or wherein the oval ratio is at least 1.5.

4. Assembly according to claim 1, wherein the foil height is at most 140 mm.

5. Assembly according to claim 1, wherein a cover percentage of wound foil on the support surface is at least 41%, preferably at least 50% and more preferably at least 60%.

6. Assembly according to claim 1, wherein a cover percentage of wound foil on the support surface is at least one of the following:
for three reels positioned on the support surface at least 41%;
for four reels positioned on the support surface at least 44%;
for five reels positioned on the support surface at least 48%;
for six reels positioned on the support surface at least 48%;
for seven reels positioned on the support surface at least 55%; or
for eight reels positioned on the support surface at least 62%.

7. Assembly according to claim 1, wherein the reels positioned on the support surface are arranged according to a pattern chosen from the set formed by:
Length×width of transport platform
Length × width of transport platform

| | | | | | | | | | |
|---|---|---|---|---|---|---|---|---|---|
| 1200 × 800 | \| \| | \| \| \| | \|= | -- | -- | | | | |
| | | | | -- | -- | | | | |
| | | | | | -- | | | | |
| 1000 × 1200 | \| \| | -\| | \| \| | / / | -/ | \| \| \| | =/ | / / / | \| \| \| \| |
| | \| \| | \|- | \| | \| \| \| | - | \| \| \| | =/ | \| \| \| \| | \| \| \| \| |
| | | | \| \| | | -/ | | | | |
| 1200 × 1200 | \| \| | -\| | \| \| | / / | \| \| \| | / / / | \| \| \| \| | =\| \| | |
| Or | \| \| | \|- | \| | \| \| \| | \| \| \| | \| \| \| \| | \| \| \| \| | \| \|= | |
| 1100 × 1100 | | | \| \| | | | | | | |

wherein ‘|’, ‘-’ (‘=’ is a double) and ‘/’ represent longitudinal, transverse and acute oriented reels respectively on the support surface.

8. Assembly according to claim 1, wherein the foil height (h) of foil wound around the core and oval ratio (Rlw) are related according to the following formula:
80<h<−0.6·R_{lw}⁴+10·R_{lw}³−64·R_{lw}²+182·R_{lw}+33 (1).
preferably:
90<h<152·R_{lw}^{-0.1} (2).

9. Assembly according to claim 1, wherein the ovally shaped reels are generally shaped as a rounded rectangulars.

10. Assembly according to claim 1, wherein at least two reels have at least 100 mm of foil height wound around the reel.

11. Assembly according to claim 1, wherein the support surface is surrounded by a circumferential edge extending upwardly from the support surface, wherein the circumferential edge is preferably formed by a cardboard boxing.

12. Assembly according to claim 1, wherein the core is formed from cardboard, has a thickness between 2 mm and 5 mm and/or has a circumference between 64 cm and 98 cm.

13. Method for arranging a label onto a container at a labelling plant, the method comprising:
providing containers at the labelling plant;
providing labels at the labelling plant; and
arranging labels onto the containers;
wherein providing labels at the labelling plant comprises:
winding, at a foil production plant, at least 80 mm of foil height of foil comprising labels onto a deformable core with an opening, thereby forming a reel,
transporting the reel from the foil production plant to the labelling plant by positioning at least three reels with a side face onto a support surface of a transport platform, of which at least two reels are ovally shaped in cross section, the opening of the reel having a oval ratio (Rlw) of length:width of at least 1.1,
unwinding the foil from the reel at the labelling plant and
cutting the unwound foil into labels.

14. Method according to claim 13, wherein the plastic foil is a heat shrinkable foil and/or wherein the plastic foil is a tubular foil.

15. Method according to claim 13, wherein the foil height of the reel is at most 140 mm.

16. Method according to claim 13, wherein the transport platforms are at least 750 mm long and at least 750 mm wide.

17. Method according to claim 13, wherein a foil height is at least 90% of the maximum of foil height that can be wound around the core, dependent on the oval ratio (Rlw), when the reel is positioned on a support surface in accordance to a predetermined reel pattern.

18. Method according to claim 13, wherein the method comprises deforming the reel at the foil production plant from generally circular reel having foil wound around the core to the ovally shaped reel.

19. Method according to claim 13, wherein the foil is wound onto an ovally shaped core.

20. Method according to claim 13, wherein unwinding the foil from the reel comprises deforming the ovally shaped reel in a generally circular reel prior to unwinding.

21. Method according to claim 13, wherein unwinding the foil from the reel comprises unwinding the foil from the ovally shaped reel.

22. Method according to claim 13, wherein the foil is a tubular foil, wherein cutting labels comprises forming sleeves and wherein arranging the label onto the container comprises arranging the sleeve around the container.
